(19) United States
(12) Patent Application Publication
(10) Pub. No.: US 2020/0034799 A1
(43) Pub. Date: Jan. 30, 2020

(54) SAC AND RIC ENABLED INTERACTIVE RECYCLING SYSTEMS

(71) Applicant: Yee Ling Elaine Wong, Hong Kong (HK)

(72) Inventor: Yee Ling Elaine Wong, Hong Kong (HK)

(21) Appl. No.: 16/047,012

(22) Filed: Jul. 27, 2018

(51) Int. Cl. G06Q 10/00; H04L 29/08; G06Q 30/02

(52) U.S. Cl. CPC G06Q 10/30; G06Q 30/0207; H04L 67/18

(57) ABSTRACT

Optimal Incentive recommendation which is related to economic incentive being available with a SAC and/or RIC processing facility is synchronized with economic incentive being provided by the processing facility. An interactive recycling bin operates to receive optimal incentive recommendation which is related to the incentive being provided with the processing facility. The system operates based on interactive recycling bin location, and the processing facility location. Based on the location, a server can determine what incentive is available with the processing facility and can therefore provide optimal incentive recommendation based on that to the interactive recycling bin. It works passively with periodic regular updates of the interactive recycling bin location or actively through the use of a button (touch screen, keyboard, etc.) on the interactive recycling bin to signal the server to check its location and therefore identifying which processing facility the interactive recycling bin is near.

### FIELD OF THE INVENTION

The present invention is a method and apparatus for providing economic incentive to consumers through their interactive recycling bins based on the proximity of a consumer's interactive recycling bins to a recycling processor or other waste disposal facility such as a landfill site or incinerator whose location is known to a server, the incentive being related to the technologies or resources being available to the recycling processor or scarcity of a landfill space.

### BACKGROUND OF THE INVENTION

The present disclosures describe interactive apparatus and methods of balancing landfill intake, recycling, and incineration and at the same time providing economic incentive to individual consumers, the incentive based on changing waste management technologies and resources available to recycling processors or processing facilities for waste codes (e.g SAC GB16288, 2008 markings, RIC codes, etc) driven processing capacity and efficiency. After conducting hundreds of “lifecycle analyses” to compare recycling with other options like landfill and incineration, following the entire chain of events from the manufacture of a product (using either virgin or recycled materials) to its disposal, scientists have concluded that a balanced approach among recycling, landfill and incineration makes the most environmental sense. Different recycling companies require different mixes and restrictions. While it is true that some incinerators also produce electricity, it is not without impact. Incineration still produces emissions into the air including air pollutants and greenhouse gases. Composting biodegradables is an effective option; however, landfills and incinerators don't pay for themselves; in fact they cost more than recycling programs. The average tipping fee at landfills in the Northeast region, according to the most recent NSWMA figures, is over $70 a ton, compared to a national average of just $34. In other words, even if the scarcity of landfill space turns out not to be a strong environmental argument for recycling, there can be powerful economic incentive to reduce landfill intake. Collecting recyclables isn't cheap—it eats up about 50 to 60 percent of the budget of a typical curbside recycling program. A recycling program should allow garbage collection to become less frequent (or to use fewer trucks), offsetting the cost and energy involved. “Single-stream” material recovery facilities allow homeowners to dump all their recycling in one bin and rely on machines to do the dirty work. Such state-of-the-art facilities now feature magnets to attract steel, eddy currents to deflect aluminum, infrared spectrometers to identify different types of plastics, and a host of other sorting technologies. These plants are expensive, and they still require some human sorters to oversee the process. Sorting plastics is tricky for recycling processors. Bottles can't be separated out with a magnet; small pieces like coffee-cup lids get flattened and mixed into paper bales; bags get caught in the spinning disks of sorting equipment, forcing frequent shut-downs. Trying to decode the recycling numbers on plastic products is also a pain for consumers. As a result, it's true that most of the plastic we use does end up in landfill sites. Less than 1 percent of polystyrene containers (e.g. yogurt pots) are recycled, and even well-established recyclables like PET (e.g. soft-drink bottles) end up in the trash more than two-thirds of the time. Anything thrown into the trash will end up in the landfill. The labor required to sort through trash after it has already been mixed is prohibitive and almost never happens. The only feasible way of separating recyclables is “source separation,” meaning each person separates their trash at the time they throw it away. Bottle caps are a wonderful example. To the recycling coordinator, it is understood that those caps and lids are often a different resin type and most know that different resins need to eventually end in different reprocessing lines (frequently at different plants) if they're going to be recycled successfully. Some universal restrictions are waxy or thermal paper (for older fax machines), laminated paper, and food-stained paper. One area where recycling plainly works is in the disposal of aluminum cans. Since the process requires 10 percent less energy than transforming bauxite into aluminum, it pays for producers to use recycled cans. Hence, a market has developed for these cans, and market incentive encourage entrepreneurs to find efficient ways to collect them. One area where recycling doesn't make sense is in the disposal of juice containers used principally by school children. Filling disposable boxes requires about half as much energy as filling the supposedly preferable alternative, glass bottles. For a given beverage volume, transporting empty glass bottles requires times as many trucks as the empty boxes—thus using more fuel and causing more air pollution. Because the end product is lightweight, small, and rectangular, the filled boxes can be transported more efficiently than full glass bottles, using 35 percent less energy.

Some developed countries or regions in the world have threatened to ban disposable diapers as a way to encourage the use (and recycling) of cloth diapers. Studies show, however, that when all environmental effects are considered, cloth has no clear advantage over disposables. In regions where there is relatively abundant landfill space and a shortage of water, the case for disposables is actually quite strong. Residents of those regions who avoid them and wash cloth diapers with scarce water may actually be doing harm to the environment. Several regions or countries have essentially banned polystyrene food packages, believing in that because paper is “biodegradable” and polystyrene is not, the switch will reduce the need for landfills. That's what McDonald's used to put its burgers in until it was pressured into switching to paperboard containers. Polystyrene, it so happens, is completely recyclable, which isn't always true of the paper used in, say, drinking cups, which by the way, cost the consumer about 2 times as much as polystyrene. Studies from NCPA and other respected organizations show that production of the old polystyrene McDonald's hamburger shell actually used 30 percent less energy than paperboard and resulted in 46 percent less air pollution and 42 percent less water pollution. The average 10-gram paper cup consumes 33 grams of wood and uses 28 percent more petroleum in its manufacture than the entire input of a polystyrene cup. Furthermore, the paper cup requires 36 times more chemical input (partly because it weighs seven times as much) and takes about 12 times as much steam, 36 times as much electricity and twice as much cooling water to make, compared to its polystyrene counterpart. And, about 580 times as much waste water, 10 to 100 times the residual effluents of pollutants, and three times the air emission pollutants are produced in making the paper cup.

### SUMMARY OF THE INVENTION

The invention enables optimal incentive recommendation which is based on incentive being available with a SAC and RIC recycling processor or provided by another processing facility to be fully synchronized with the incentive that is available with the recycling processor or other processing facilities. In this regard, optimal incentive recommendation which is based on incentive which is available based on the best combination of incentives that is being available for the recycling processor or other processing facilities. Additionally, as used herein, optimal incentive recommendation is available in response to incentive that is available with the recycling processor or other processing facilities. Simply by pressing a button on an interactive recycling bin, or otherwise activating software on the device, relevant and targeted incentive transfers based on incentive available with the recycling processor or other processing facilities is provided to the interactive recycling bin via a server. No Wi-Fi or Bluetooth™ connection is needed. The user only needs a data connection to a wireless carrier such as Verizon™, AT&T™, T-Mobile™, etc. However, in some situations, the signals from a Bluetooth™ beacon can be used as trigger as explained below.

The system presented can work alone without any communication between the interactive recycling bin and recycling processors or other processing facilities wherever located; it is based on an interactive recycling bin to server communication of the interactive recycling bin location and, optionally, the waste codes and markings. Based on the time, when needed, and communicated location, the server can determine what incentive is available with the recycling processor and can therefore provide synchronized rewards. It works passively with periodic regular updates of the interactive recycling bin location or actively through the use of a button (touch screen, keyboard, etc.) on the interactive recycling bin to signal the server to check its location and therefore identifying which recycling processor or other processing facility the interactive recycling bin is near.

The uniqueness of the technology relies on proximity and, when necessary, waste codes and markings to completely synchronize the incentive with recycling processors or other processing facility with interactive recycling bins and enables sharing and syncing of incentive available with the processing facility which include, by way of example, recycling processors, landfill sites, or incinerators without the need of a Wi-Fi, or Bluetooth™ connection, and only a simple data connection to a wireless carrier. Such recycling processor may or may be online and may or may not be able to transmit plant capacity or resources utilization data to another server. Recycling processors with communications ability enable additional features of the invention to be utilized, but such communications ability is not required in many situations. In the case of such static facilities, since the incentive announcement is relatively fixed or static, the optimal incentive recommendation provided to the interactive recycling bin does not depend on waste codes and markings as is the case with economic incentive which changes over relatively short periods of time. The static facility can send these triggers to the consumer's interactive recycling bin based on location, via GPS location technologies, via Bluetooth™ beacons or any other location based technology available today or in the future. There are several different implementations and embodiments for the present invention, however at a minimum level it provides a method and apparatus allowing for the determination of a consumer's proximity to a particular recycling processor or other waste processing facility. Furthermore it can determine the incentive being available with every recycling processor or other waste processing facility in the system so that it can then provide to the consumer optimal incentive recommendation on their interactive recycling bin.

The consumer is provided optimal incentive recommendation on their interactive recycling bin. One incentive may be a credit or special reward for the waste material they dispose via the processing facility, which they can then claim at any point in the future. These rewards can be directly related to the waste material types they dispose with the processing facility, or cross-marketed towards them based on their disposal patterns, recycling frequency, etc.

In one variation of the above—the interactive recycling bin prompts the user simply by notifying them that there is supplemental incentive. The user can then request (pull) optimal incentive recommendation (perhaps selecting specific information/incentive).

The present invention requires very little intervention on the part of the consumer. The system automatically handles all aspects of determining both the correct location of the recycling processor or other processing facility, location of the consumer and correct incentive being available with the recycling processor or provided by other processing facility.

The technology presented can work alone without any communication between the interactive recycling bin and recycling processors or other processing facility at any location; it is based on the interactive recycling bin to server communication of the interactive recycling bin location, the location of the recycling processor and if needed, the waste codes and markings. Based on the time, when needed, and location, the server determines what incentive is available with the recycling processor and can therefore provide synchronized rewards. When the incentive is static, the time is not needed since the incentive does not change over time. It works passively with periodic regular updates of the interactive recycling bin location or actively through the use of a button (touch screen, keyboard, etc.) on the interactive recycling bin to signal the server to check its location and therefore identifying which recycling processor the mobile is near.

The technology presented can utilize a variety of technologies to determine its present longitude and latitude as available on the specific interactive recycling bin or recycling processor or other processing facilities. These include Global Positioning Satellite (GPS), Bluetooth™ beacons, cellular towers (using triangulation), etc. The only requirement is that the device can send either passively or actively its coordinates (longitude and latitude) to the service

### BRIEF DESCRIPTION OF THE DRAWINGS

FIG. 1 shows a system showing the work flow between an interactive recycling bin and a processing facility, consistent with an embodiment of the present invention.

FIG. 2 shows an inventive interactive recycling bin, consistent with an embodiment of the present invention.

FIG. 3 shows an inventive interactive recycling bin controlled by a remote device, consistent with an embodiment of the present invention.

FIG. 4 shows an inventive interactive recycling bin controlled by a remote device through a credit system, consistent with an embodiment of the present invention.

A better understanding of the disclosed technology will be obtained from the following detailed description of embodiments of the disclosed technology, taken in conjunction with the drawings.

### DETAILED DESCRIPTION

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

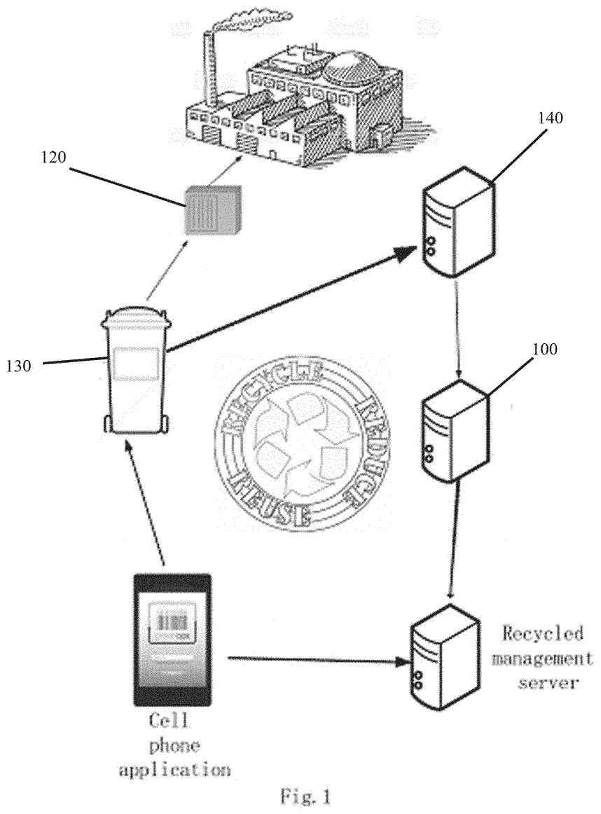

The minimum requirement is that recycling processors or other processing facilities must be capable of receiving a data feed online by way of an economic incentive server 100. In most cases, the economic incentive server is a remote device and the data feed is provided over a network. FIG. 1 shows a system showing the work flow between an interactive recycling bin and a processing facility 110, but of course any number of processing facilities can be provided.

One or more transport logistics servers 120 contain information on the location of each and every recycling processor or other processing facility in the system. This information can be updated manually by an operator or in an automated manner as is described and detailed in the various implementations. For static recycling processors, the location can also be provided to the transport logistics server.

Interactive recycling bin 130 is capable of data communications, receiving and displaying information for the consumer from a remote server, and transmitting user input to a remote server. In addition, these devices must be able to provide geographical location of the device in real-time.

A variety of location services are in wide use in software and via the Internet at this point in time for effectively locating a position anywhere on earth using longitude and latitude coordinates. It is a common practice to perform calculation of distances between two sets of coordinates to determine proximity to another location or object. Region detection processing server 140 utilizes location information provided by an interactive recycling bin's use of such location services.

Economic Incentive Lookup Server 100 and Incentive Optimization Processing. Optimal incentive recommendation can be any form of data that can be sent to and processed by an interactive recycling bin for further consumer interaction.

Economic Incentive Service—One or more economic incentive look up servers connected to a private or public communications network provide access to incentives related to the location of individual processing facilities 110. The information contained within the data tables on server includes at a minimum the following details:

Processing Facility ID—A unique identifier for a processing facility 110.

Longitude—A numeric value related to a specific longitude of each processing facility 110.

Latitude—A numeric value related to a specific latitude of each processing facility 110.

Last Start Time—A time value representing the last time the data being provided was started on the economic incentive look up server 100.

Incentive ID—Details on incentive data including time code and identification codes related to specific incentive available from an incentive optimization server.

When a processing facility 110 is initiated, it communicates with economic incentive look up server 100 sending it a request for a specific incentive ID as programmed by the operator. Upon receiving the request, the server begins to send the requested incentive data to the processing facility 110. At the beginning of the initialization, server may set the “Last Start Time” in a recycling processor location data table located on server as the present time on the server.

Incentive Optimization Service—One or more incentive optimization servers connected to a private or public communications network provide access to an incentive data related to one or more programs which are identified by a specific incentive ID which is unique for each data feed. The information contained within the data tables on incentive optimization server includes at a minimum the following details:

Processing Facility ID—This directly corresponds with the identification of a specific recycling processor, landfill site, or incinerator.

Incentive ID—An identification of the incentive being available with the recycling processor or other processing facilities.

Time(s)—One or more times (specific time(s)/date(s) or time/date range(s) for the incentive being available with the recycling processor or other processing facilities.

Optimal Incentive Recommendation—The incentive from incentive optimization server to be served to the interactive recycling bin.

The economic incentive server and incentive optimization server may be separate physical servers or contained on a single physical server. In all cases, the data that is available on server and on server is shared and accessible by both servers.

region detection Process—One or more region detection process servers connected to a private or public data communications network provide the ability to determine the nearest location of a recycling processor based on a given longitude and latitude of an interactive recycling bin and the location of the processor or facility.

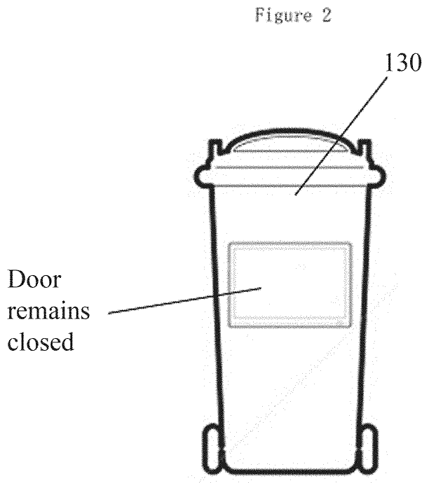

FIG. 2. shows an inventive interactive recycling bin. Interactive recycling bin is capable of a) sending its present longitude/latitude, b) communicating with remote servers via communications networks, c) sending requests to a remote server, d) receiving and displaying data/information received from a remote server.

Each such device contains a client application capable of processing data specific to the application and utilizes the capabilities of the specific device. The specifics of such application are not important to an understanding of the invention and the requirements to write code for such applications are well within the abilities of persons skilled in the art based on the descriptions provided herein.

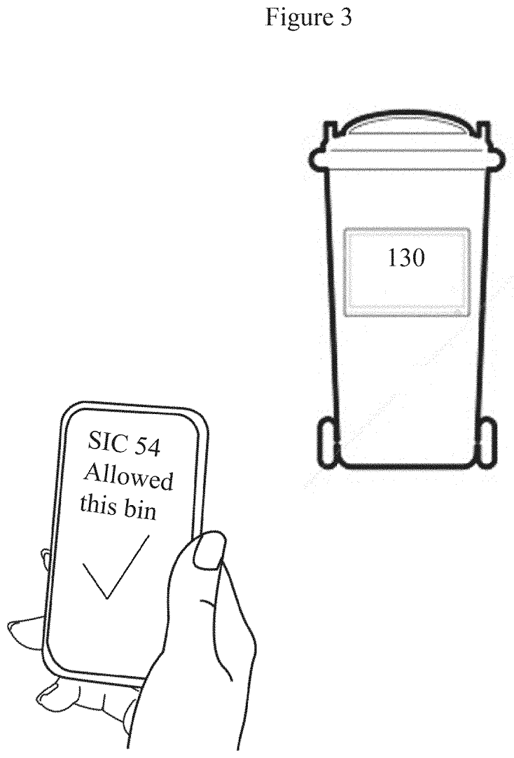

FIG. 3 shows an inventive interactive recycling bin controlled by a remote device. The remote device may be a mobile phone or any other mobile device and can establish communication with a connected interactive recycling bin.

Each interactive recycling bin has a unique client ID and uses an existing location service such as GPS, Bluetooth™ beacon, WiFi or any other location based technology to determine its current latitude/longitude. The ID and location are the minimum required information needed to be provided by each interactive recycling bin. The ID represents the individual interactive recycling bin, the longitude and latitude represent its present location. As the mobile client changes locations, its longitude/latitude are updated and sent to region detection process.

At the point where the interactive recycling bin requests synchronization with a particular processing facility, it sends its client ID and its present location (longitude/latitude coordinates) to region detection process.

Upon receiving a request, region detection process calculates the distance between the interactive recycling bin and the nearest location of known operating processing facility. If one is within range of the interactive recycling bin, economic incentive lookup performs an additional lookup on incentive optimization server. The range can vary based on recycling processor size, location and other factors.

At any point where an interactive recycling bin has made a synchronization request with region detection process server and the server has determined the nearest processing facility, server performs a lookup using incentive lookup server. The incentive lookup server and incentive optimization server may be on the same physical server or on a separate server. In either case the information from both servers is available to the economic incentive server which may also be part of the same server or a separate server.

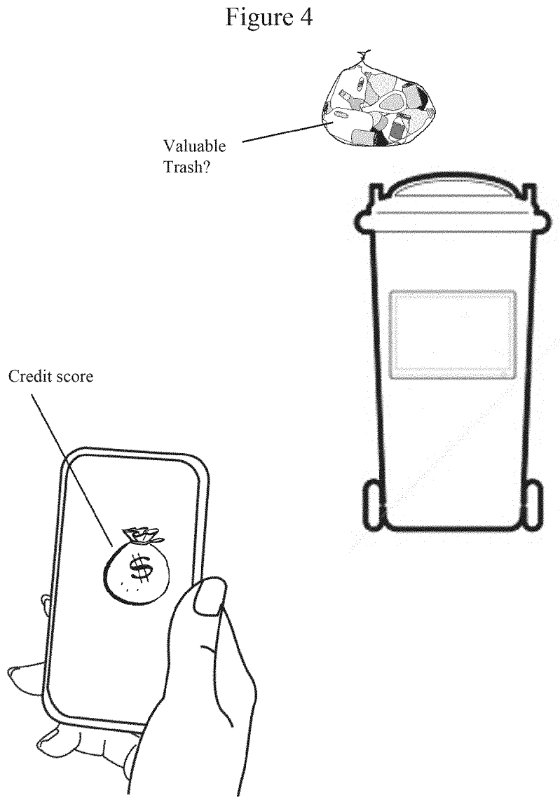

FIG. 4 shows an inventive interactive recycling bin controlled by a remote device through a credit system. The credit system stores the credit associated with a particular user. The purpose of the credit system is to encourage more users to recycle trash. Every time when a user recycle trash using the inventive system, credit score will be incremented based on the type and volume of the underlying trash.

Using the processing facility ID identified as the nearest recycling processor location, the transport logistics server looks up the incentive ID and Last Start Time which corresponds to the data feed and the time on the server when the processing facility first began the data feed.

The transport logistics server performs a calculation using the present time and subtracting the start time to determine the time difference.

Using the above data, transport logistics server can now perform a lookup of optimal incentive for the specific data feed ID and a timecode matching the present time in the data by using the recycling processor ID, incentive ID, and data feed timecode as the key to incentive in processing facility.

The returned data is sent from incentive optimization server and corresponds to the specified time, data feed, and processing facility based on the initiating request from transport logistics server.

In other embodiments, the transport logistics server instead of performing a lookup of optimal incentive for the specific data feed ID and a timecode matching the present time in the data, by using the processing facility ID as the key to related data in processing facility, the processing facility or other service related to the processing facility can send its location and incentive to the transport logistics server and economic incentive lookup server 23a. That is, the same information which is generated by these devices can instead be provided directly by the recycling processor or a processing facility related service by providing the incentive and location. Such information can be provided by any device programmed with the incentive and location information which can then send the information to the servers with an indication that no special incentive processing is necessary other than to associate the provided location with the available incentive.

Users of the present invention use an interactive recycling bin with a suitable “client application” (software program). The client application sends its location (longitude and latitude) to the region detection process server. The user can interact with the client application and request that the application send its present location.

The region detection process server determines the approximate distance of the interactive recycling bin from the location of processing facilities. Based on the location of the nearest processing facility, the service determines whether it is possible for the user to be within range of the processing facility.

If it is determined that the possibility exists for the user to be in range of the recycling processor or speaker, the client application is provided with optimal incentive recommendation from the incentive optimization server specific to the incentive presently available with processing facility in the range of the user.

The client application uses its internal programming to present the optimal incentive recommendation to the user. The incentive is unlimited, however it is directly related to the location of the processing facility that was originally disposing with.

The client application can further process the received incentive based on the type of incentive and interaction with the user. Examples at this point in the process might include storing the incentive for future use, accessing a deeper level of incentive pertaining to the optimal incentive recommendation, sharing the incentive with others, sending the incentive to another device, etc.

Servers, and can be operated from a single physical server, be spread among multiple physical servers, or may reside on a cloud-based computing service. The data the servers access and use in processing requests may be contained on the same server in a machine readable format or can be stored on separate database server.

As noted above, each processing facility has a unique identifier and can present incentive which is unique to that location or identical to that which is available with other processing facilities in multiple locations.

A user presses the button, signaling the software on the mobile phone to send its latitude/longitude to region detection process server. The software on the interactive recycling bin is also configurable to periodically send the latitude/longitude to transport logistics server at specified time intervals (e.g. every 30 seconds). The method chosen would be based on the planned environment and those designing the particular mobile application user experience.

It is also important to note that the longitude and latitude may be by any means available to the device. The present means include Global Positioning Satellites (GPS), Cellular Tower Locater Servers, Wi-Fi Triangulation, and Bluetooth™ proximity. As this area of technology is rapidly advancing, interactive recycling bins can and will use a variety of different means to get their location. New technologies are of benefit in that they provide better reach (e.g. they can be used in more places and with less interruption due to environmental conditions) and they can provide increased accuracy (e.g. within 9 feet vs. 50 feet). In all cases—it is the ability to send longitude and latitude of the interactive recycling bin that enables the other system elements to send the appropriate optimal incentive recommendation to the interactive recycling bin.

Upon receiving longitude/latitude coordinates from an interactive recycling bin 19, the region detection process server evaluates whether the location of the consumer is within a given proximity to any of the processing facilities that it knows as provided by transport logistics server. If region detection process server determines that the consumer is within a set proximity, transport logistics server will then determine what optimal incentive recommendation is available on a particular processing facility at the present time.

What is claimed:

1. A system for enabling optimal incentive recommendation based on economic incentive being provided by at least one waste processing facility to be sent to an interactive recycling bin comprising:
a) a region detection process server configured to receive location information from said interactive recycling bin and determine a location of a nearest one of said at least one waste processing facility, and determine whether the interactive recycling bin is within a predetermined distance from said determined location;
b) an economic incentive lookup server coupled to said region detection process server configured to determine if predetermined incentive exists which corresponds to incentive available with said at least one waste processing facility at said determined location and said interactive recycling bin is determined to be within said predetermined distance;
c) a transport logistics server configured to operate in coordination with said location detection process server, said economic incentive lookup server, and an incentive optimization server to cause said incentive optimization server to send data to said interactive recycling bin which is related to said incentive available with said waste processing facility at said determined location if said interactive recycling bin is determined to be within said predetermined distance.

2. The system defined by claim 1 wherein said region detection process server determines the location of the nearest one of said at least one waste processing facility by accessing a data table maintained by said transport logistics server which contains a processing facility identifier and a latitude and longitude for each of said at least one processing facility.

3. The system defined by claim 1 wherein said economic incentive lookup server and said transport logistics server operate to determine if said incentive optimization server includes data which is related to said incentive on said processing facility at said determined location using a processing facility ID corresponding to said processing facility, and an incentive ID corresponding to said incentive.

4. The system defined by claim 3 wherein said transport logistics server further operates to perform a lookup of incentive optimization for said incentive provided by said processing facility corresponding to a incentive ID by using the processing facility ID, and the incentive ID.

5. The system defined by claim 4 wherein said transport logistics server further operates to instruct said incentive optimization server to send said incentive optimization data to said interactive recycling bin determined to be within said predetermined distance using a related incentive table having records wherein for each incentive ID, there is a corresponding processing facility ID and a corresponding optimal incentive ID.

6. The system defined by claim 1 wherein said processing facility is a recycling processor.

7. The system defined by claim 1 where said at least one processing facility has a moving location which location is dynamically provided to said region detection process server.

8. A method for providing optimal incentive recommendation to an interactive recycling bin which is based on incentive available with a processing facility comprising:
a) sending a location and incentive available with said processing facility;
b) determining a location of the interactive recycling bin by receiving location information from said interactive recycling bin;
c) if said processing facility location and interactive recycling bin location are within a predetermined distance of each other, sending incentive to said interactive recycling bin which is related to said incentive available with said processing facility.

9. A method for enabling optimal incentive recommendation based on incentive available with at least one processing facility to be sent to an interactive recycling bin comprising:
a) receiving location information from said interactive recycling bin;
b) determining a location of a nearest one of said at least one processing facility to said received location;
c) determining whether the interactive recycling bin is within a predetermined distance from said determined location;
d) determining if predetermined incentive optimization exists which corresponds to said incentive provided by said processing facility at said determined location;
e) sending data to said interactive recycling bin which is related to said incentive provided by said processing facility at said determined location if said interactive recycling bin is determined to be within said predetermined distance.

10. The method defined by claim 8 wherein said determining a location and incentive being provided comprises accessing a data table which contains a processing facility identifier and latitude and longitude for said processing facility.
